(19) United States
(12) Patent Application Publication
(10) Pub. No.: US 2018/0184582 A1
(43) Pub. Date: Jul. 5, 2018

(54) TWO-SIDED RAKING DEVICE

(71) Applicant: John F. Orlos, Ruidoso, NM (US)

(72) Inventor: John F. Orlos, Ruidoso, NM (US)

(21) Appl. No.: 15/837,878

(22) Filed: Dec. 11, 2017

Related U.S. Application Data
(60) Provisional application No. 62/498,552, filed on Dec. 30, 2016.

(51) Int. Cl. A01D 7/08; A01D 7/06

(52) U.S. Cl. CPC A01D 7/08; A01D 7/06

(57) ABSTRACT

A two-sided raking device for inside and/or outside use. The raking device includes a handle operable to be held by a user. The raking device also includes a rake adapter coupled to the handle at a top end of the rake adapter. The rake adapter includes a body comprising a plurality of apertures. The rake adapter also includes a first aperture at a bottom end of the body configured to receive a first rake head. The rake adapter further includes a second aperture at the bottom end of the body configured to receive a second rake head. The raking device may include the first rake head coupled to the body of the rake adapter through the first aperture and the second rake head coupled to the body of the rake adapter through the second aperture.

### CROSS-REFERENCES TO RELATED APPLICATIONS

This application is a nonprovisional of and claims the benefit of priority to U.S. Provisional Patent Application No. 62/498,552, filed Dec. 30, 2016, entitled “FLIP-RAKE HEAD ASSEMBLY,” the content of which is herein incorporated in its entirety.

### BACKGROUND

Certain outdoor projects may require a user to constantly switch between different types of rakes. For example, a particular project may require both collecting leaves and leveling soil beneath the leaves. As a user works through the project area he/she may first use a rake having widely-spaced plastic teeth secured by a plastic intersecting beam to collect the leaves, and subsequently use a second rake having narrowly-spaced steel teeth secured by a steel intersecting beam to level the soil beneath the leaves. The time required to switch between different rakes decreases the efficiency of the project. Accordingly, there is a need for new techniques, methods, and devices in the area.

### SUMMARY

Embodiments of the present disclosure include a raking device. The raking device may include a handle operable to be held by a user. The raking device may also include a rake adapter coupled to the handle at a top end of the rake adapter. The rake adapter may include a body comprising a plurality of apertures. The rake adapter may also include a first aperture at a bottom end of the body configured to receive a first rake head. The rake adapter may further include a second aperture at the bottom end of the body configured to receive a second rake head. In some embodiments, the raking device may include the first rake head coupled to the body of the rake adapter through the first aperture. In some embodiments, the raking device may include the second rake head coupled to the body of the rake adapter through the second aperture.

In some embodiments, the first rake head is oriented in a first direction and the second rake head is oriented in a second direction, and wherein the first direction is opposite or substantially diametrically opposite the second direction. In some embodiments, the raking device includes a fastener coupled to one or both of the first rake head and the second rake head through a side aperture at a side of the body of the rake adapter. In some embodiments, the first rake head and the second rake head form an angle between 5 and 20 degrees. In some embodiments, the rake adapter is integrated with the rake handle. In some embodiments, the rake adapter is configured such that the first aperture is aligned with the rake handle such that at least part of the first rake head is aligned with the handle when the first rake head is coupled to the body of the rake adapter through the first aperture. In some embodiments, the rake adapter is configured such that the second aperture is aligned with the rake handle such that at least part of the second rake head is aligned with the handle when the second rake head is coupled to the body of the rake adapter through the second aperture. In some embodiments, the rake adapter is stainless steel. In some embodiments, the first rake head is stainless steel. In some embodiments, the second rake head is plastic.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1A illustrates a front view of a raking device, according to an embodiment of the present disclosure.

FIG. 1B illustrates a back view of a raking device, according to an embodiment of the present disclosure.

FIG. 2A illustrates a front view of a raking device, according to an embodiment of the present disclosure.

FIG. 2B illustrates a side view of a raking device, according to an embodiment of the present disclosure.

FIG. 3A illustrates a front view of a raking device, according to an embodiment of the present disclosure.

FIG. 3B illustrates a side view of a raking device, according to an embodiment of the present disclosure.

FIG. 4A illustrates a front view of a raking device, according to an embodiment of the present disclosure.

FIG. 4B illustrates a side view of a raking device, according to an embodiment of the present disclosure.

FIG. 5A illustrates a front view of a raking device, according to an embodiment of the present disclosure.

FIG. 5B illustrates a side view of a raking device, according to an embodiment of the present disclosure.

FIG. 6A illustrates a perspective view of a raking device, according to an embodiment of the present disclosure.

FIG. 6B illustrates a perspective view of a raking device, according to an embodiment of the present disclosure.

FIG. 6C illustrates an exploded, perspective view of a raking device, according to an embodiment of the present disclosure.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label irrespective of the suffix.

### DETAILED DESCRIPTION

Embodiments of the present disclosure relate to two-sided raking tools for inside and/or outside use. A two-sided raking tool as described herein may have a first rake head configured on a first side of the raking tool that may be used similar to a conventional rake. During use, a user may decide to rotate the two-sided raking tool by, e.g., rotating a handle, such that a second rake head on a second side of the raking tool may be used similar to a conventional rake. The user may continue to rotate the two-sided raking tool and alternate between the two rake heads as a project demands. For example, a particular project may require both collecting leaves and leveling soil beneath the leaves. As a user works through the project area he/she may first use a first rake head having widely-spaced plastic teeth secured by a plastic intersecting beam to collect the leaves, and subsequently use a second rake head having narrowly-spaced steel teeth secured by a steel intersecting beam to level the soil beneath the leaves. As another example, another project may require dethatching a lawn and clearing the removed thatch. As a user works through the project area he/she may first use a first rake head having thin narrowly spaced steel teeth to dethatch the lawn, and subsequently use a second rake head having widely-spaced plastic teeth to clear the removed thatch. Other possibilities are contemplated.

Advantages of embodiments of the present disclosure include, but are not limited to: (1) increased cost-savings by eliminating the need to purchase multiple tools to accomplish a project that may be accomplished with a single two-sided raking tool, (2) increased cost-savings by allowing a user to replace only a rake head portion instead of an entire raking tool when the rake head is damaged, (3) increased efficiency by eliminating the time needed to move from the project area, set aside a first rake, pick up a second rake, and return to the project area, (4) increased durability and longevity of the tool itself, as the two-sided raking tool has superior durability compared to conventional rakes due to the strength and placement of the rake adapter, (5) increased user flexibility as a user may customize which rake heads to attach to the rake adapter, and the like.

Although embodiments described herein include two different rake heads, this may not necessarily be the case in all embodiments. In some embodiments, the first rake head and the second rake head may be identical rake heads so that a user may continue to work in a project area after one of the rake heads becomes damaged. This may be particularly advantageous in situations where the likelihood of a rake head becoming damaged is high, for example, when raking heavy materials, e.g., rocks, broken concrete, etc.

As used herein, a “rake”, a “raking tool”, or a “raking device” may be used interchangeably and may refer to any tool comprising an implement or any portion of a tool that may potentially be coupled to an implement. In some embodiments, the implement may include a toothed bar fixed transversely to a handle, and may be used to collect leaves, grass, dirt, and the like. In some embodiments, the implement may include a solid or semi-solid material used to collect dirt, snow, water, and the like.

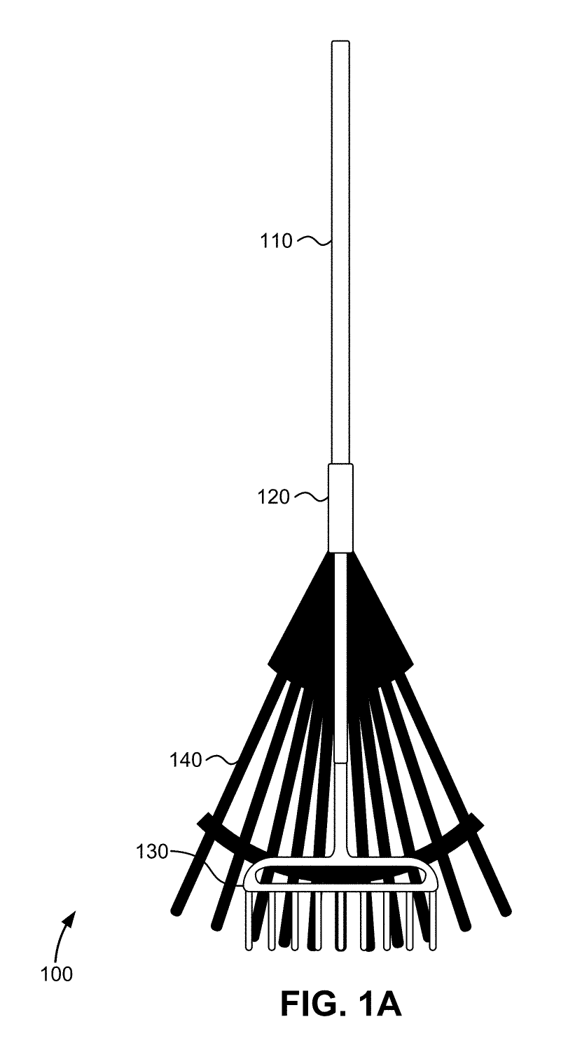

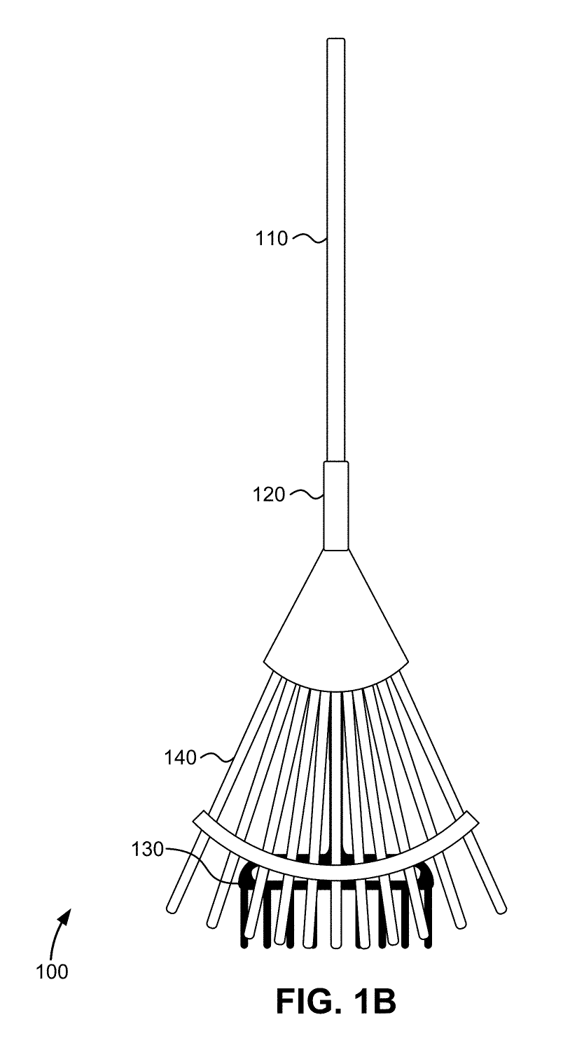

FIG. 1A illustrates a front view of a raking device 100, according to an embodiment of the present disclosure. Raking device 100 may include a handle 110 operable to be held, secured, and/or grasped by a user while operating raking device 100. Handle 110 may be uniform in a longitudinal direction and may have, among other possibilities, a circular, square, rectangular, or triangular cross section. In some embodiments, handle 110 may include one or more non-uniform regions that may include, for example, grip pads or surfaces that facilitate improved handling by a user. Handle 110 may be made from wood, metal, stainless steel, plastic, fiberglass, and the like. One end of handle 110 may include an externally-threaded portion such that handle 110 may be screwed into a top portion of rake adapter 120 having an internally-threaded aperture.

In some embodiments, raking device 100 includes a rake adapter 120 coupled to handle 110 at a top side of rake adapter 120 and to a first rake head 130 and a second rake head 140 at a bottom side of raking adapter 120. In some embodiments, each of first rake head 130 and second rake head 140 include stem portions having a similar cross section to handle 110 that couple to rake adapter 120 at a bottom side of rake adapter 120. In some embodiments, the stem portions of first rake head 130 and second rake head 140 have a length in a longitudinal direction roughly 0.1% to 50% of the length of handle 110. In some embodiments, rake adapter 120 is coupled to only one of first rake head 130 and second rake head 140. In the same embodiments, first rake head 130 may be directly coupled to second rake head 140.

In the specific implementation shown in FIG. 1A, first rake head 130 includes narrowly-spaced teeth secured by a straight intersecting beam and second rake head 140 includes widely-spaced teeth secured by a curved intersecting beam, and the stem portion of first rake head 130 has a length greater than the stem portion of second rake head 140, which is not visible in FIG. 1A. In some implementations, handle 110 may be integrated with the stem portion of one of first rake head 130 and second rake head 140. In such implementations, rake adapter 120 may be coupled to handle 110 by inserting handle 110 through an aperture of rake adapter 120.

FIG. 1B illustrates a back view of raking device 100, according to an embodiment of the present disclosure. One or more components of raking device 100 shown in FIG. 1B may correspond to one or more components of raking device 100 shown in FIG. 1A.

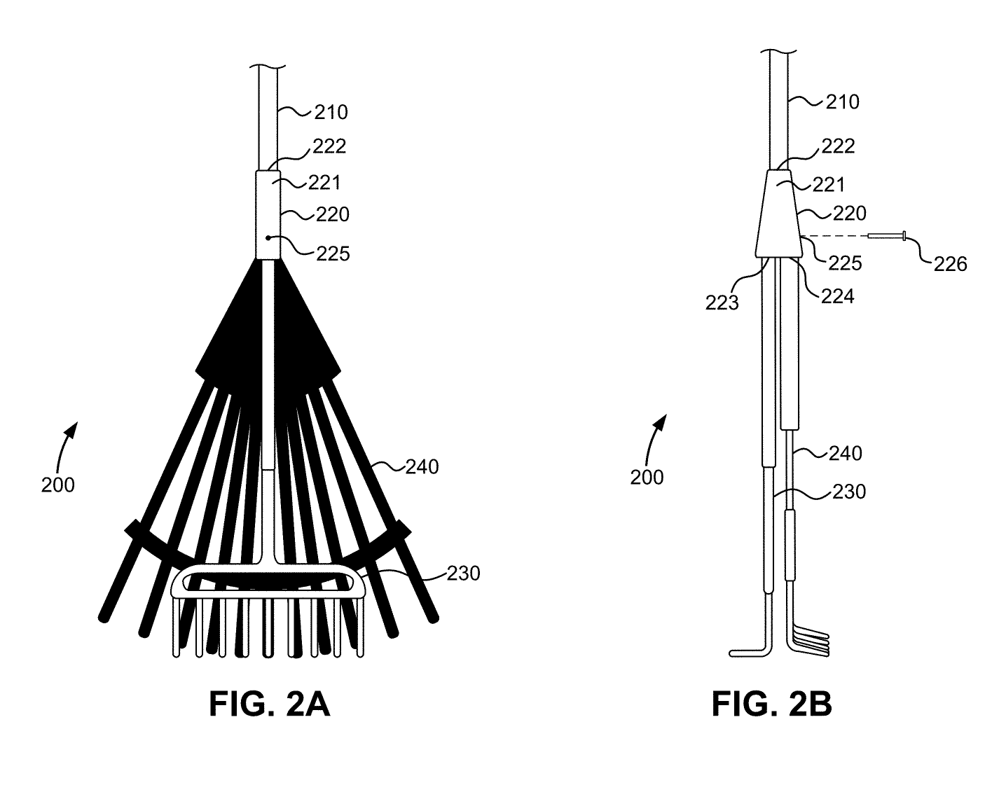

FIG. 2A illustrates a front view of a raking device 200, according to an embodiment of the present disclosure. One or more components of raking device 200 may be similar or different than one or more components of raking device 100. In some embodiments, raking device 200 includes a handle 210 coupled to a rake adapter 220 having a body 221 comprising a plurality of apertures, including a first aperture 223 at a bottom end of body 221 configured to receive a first rake head 230, a second aperture 224 at a bottom end of body 221 configured to receive a second rake head 240, a top aperture 222 at a top end of body 221 configured to receive handle 210, and a side aperture 225 at a side of body 221 configured to receive a fastener 226.

Top aperture 222 may include an internally-threaded portion configured to receive an externally-threaded portion of handle 210 such that the externally-threaded portion of handle 210 may be screwed into the internally-threaded portion of top aperture 222. In other embodiments, top aperture 222 may employ alternative coupling means such as a fitted connection, a bolted connection, and the like. Similarly, side aperture 225 may include an internally-threaded portion configured to receive an externally-threaded portion of fastener 226 such that the externally-threaded portion of fastener 226 may be screwed into the internally-threaded portion of side aperture 225. Alternatively, one or both of the stem portions of first rake head 230 and second rake head 240 may include an aperture for receiving fastener 226, and may further include an internally-threaded portion for receiving the externally-threaded portion of fastener 226. In some embodiments, the stem portions of one or both of first rake head 230 and second rake head 240 may extend through first aperture 223 and second aperture 224 (respectively) at a distance sufficient such that fastener 226 may couple to one or both of first rake head 230 and second rake head 240.

First aperture 223 and second aperture 224 may employ one or more of various possible connection types for coupling to first rake head 230 and second rake head 240, respectively, such as a threaded connection, a fitted connection, a bolted connection, and the like. In some embodiments, first rake head 230 may couple to body 221 through first aperture 223 using a threaded connection, and second rake head 240 may couple to body 221 through second aperture 224 using a bolted connection. Such embodiments may be assembled by first inserting and rotating first rake head 230 followed by inserting second rake head 240. In some embodiments, both first rake head 230 and second rake head 240 may couple to body 221 through first aperture 223 and second aperture 224 (respectively) using a bolted connection. Other possibilities are contemplated.

FIG. 2B illustrates a side view of raking device 200, according to an embodiment of the present disclosure. One or more components of raking device 200 shown in FIG. 2B may correspond to one or more components of raking device 200 shown in FIG. 2A. In some embodiments, an angle is formed between first rake head 230 and second rake head 240 based on the internal angles of first aperture 223 and second aperture 224. In the particular implementation shown in FIG. 2B, the angle is equal to zero such that first rake head 230 and second rake head 240 are parallel.

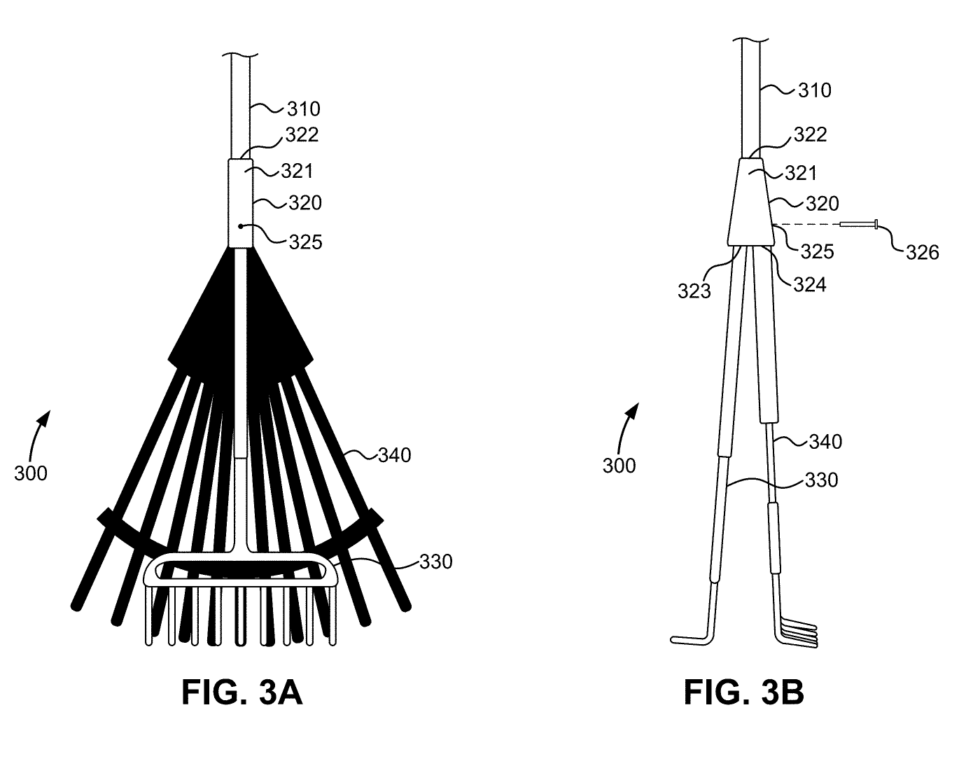

FIG. 3A illustrates a front view of a raking device 300, according to an embodiment of the present disclosure. One or more components of raking device 300 may be similar or different than one or more components of raking devices 100 and 200. In some embodiments, raking device 300 includes a handle 310 coupled to a rake adapter 320 having a body 321 comprising a plurality of apertures, including a first aperture 323 at a bottom end of body 321 configured to receive a first rake head 330, a second aperture 324 at a bottom end of body 321 configured to receive a second rake head 340, a top aperture 322 at a top end of body 321 configured to receive handle 310, and a side aperture 325 at a side of body 321 configured to receive a fastener 326.

Top aperture 322 may include an internally-threaded portion configured to receive an externally-threaded portion of handle 310 such that the externally-threaded portion of handle 310 may be screwed into the internally-threaded portion of top aperture 322. In other embodiments, top aperture 322 may employ alternative coupling means such as a fitted connection, a bolted connection, and the like. Similarly, side aperture 325 may include an internally-threaded portion configured to receive an externally-threaded portion of fastener 326 such that the externally-threaded portion of fastener 326 may be screwed into the internally-threaded portion of side aperture 325. Alternatively, one or both of the stem portions of first rake head 330 and second rake head 340 may include an aperture for receiving fastener 326, and may further include an internally-threaded portion for receiving the externally-threaded portion of fastener 326. In some embodiments, the stem portions of one or both of first rake head 330 and second rake head 340 may extend through first aperture 323 and second aperture 324 (respectively) at a distance sufficient such that fastener 326 may couple to one or both of first rake head 330 and second rake head 340.

First aperture 323 and second aperture 324 may employ one or more of various possible connection types for coupling to first rake head 330 and second rake head 340, respectively, such as a threaded connection, a fitted connection, a bolted connection, and the like. In some embodiments, first rake head 330 may couple to body 321 through first aperture 323 using a threaded connection, and second rake head 340 may couple to body 321 through second aperture 324 using a bolted connection. Such embodiments may be assembled by first inserting and rotating first rake head 330 followed by inserting second rake head 340. In some embodiments, both first rake head 330 and second rake head 340 may couple to body 321 through first aperture 323 and second aperture 324 (respectively) using a bolted connection. Other possibilities are contemplated.

FIG. 3B illustrates a side view of raking device 300, according to an embodiment of the present disclosure. One or more components of raking device 300 shown in FIG. 3B may correspond to one or more components of raking device 300 shown in FIG. 3A. In some embodiments, an angle is formed between first rake head 330 and second rake head 340 based on the internal angles of first aperture 323 and second aperture 324. In the particular implementation shown in FIG. 3B, the angle is approximately equal to 10 degrees.

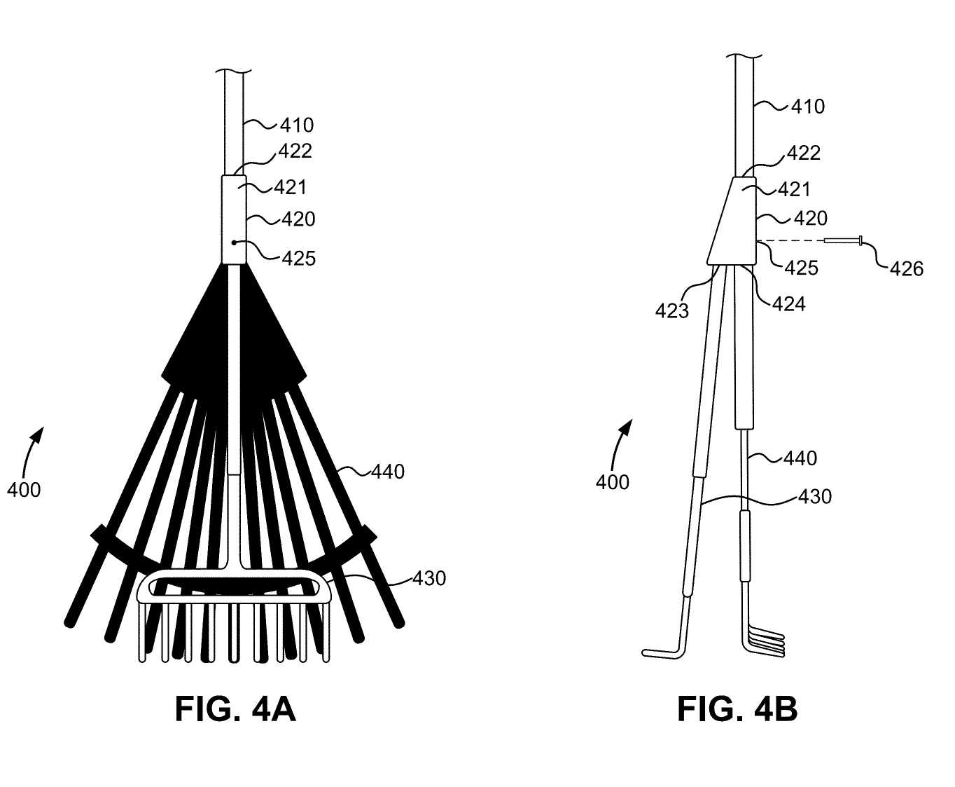

FIG. 4A illustrates a front view of a raking device 400, according to an embodiment of the present disclosure. One or more components of raking device 400 may be similar or different than one or more components of raking devices 100, 200, and 300. In some embodiments, raking device 400 includes a handle 410 coupled to a rake adapter 420 having a body 421 comprising a plurality of apertures, including a first aperture 423 at a bottom end of body 421 configured to receive a first rake head 430, a second aperture 424 at a bottom end of body 421 configured to receive a second rake head 440, a top aperture 422 at a top end of body 421 configured to receive handle 410, and a side aperture 425 at a side of body 421 configured to receive a fastener 426.

Top aperture 422 may include an internally-threaded portion configured to receive an externally-threaded portion of handle 410 such that the externally-threaded portion of handle 410 may be screwed into the internally-threaded portion of top aperture 422. In other embodiments, top aperture 422 may employ alternative coupling means such as a fitted connection, a bolted connection, and the like. Similarly, side aperture 425 may include an internally-threaded portion configured to receive an externally-threaded portion of fastener 426 such that the externally-threaded portion of fastener 426 may be screwed into the internally-threaded portion of side aperture 425. Alternatively, one or both of the stem portions of first rake head 430 and second rake head 440 may include an aperture for receiving fastener 426, and may further include an internally-threaded portion for receiving the externally-threaded portion of fastener 426. In some embodiments, the stem portions of one or both of first rake head 430 and second rake head 440 may extend through first aperture 423 and second aperture 424 (respectively) at a distance sufficient such that fastener 426 may couple to one or both of first rake head 430 and second rake head 440.

First aperture 423 and second aperture 424 may employ one or more of various possible connection types for coupling to first rake head 430 and second rake head 440, respectively, such as a threaded connection, a fitted connection, a bolted connection, and the like. In some embodiments, first rake head 430 may couple to body 421 through first aperture 423 using a threaded connection, and second rake head 440 may couple to body 421 through second aperture 424 using a bolted connection. Such embodiments may be assembled by first inserting and rotating first rake head 430 followed by inserting second rake head 440. In some embodiments, both first rake head 430 and second rake head 440 may couple to body 421 through first aperture 423 and second aperture 424 (respectively) using a bolted connection. Other possibilities are contemplated.

FIG. 4B illustrates a side view of raking device 400, according to an embodiment of the present disclosure. One or more components of raking device 400 shown in FIG. 4B may correspond to one or more components of raking device 400 shown in FIG. 4A. In some embodiments, second aperture 424 may be aligned with handle 410 such that second rake head 440 is aligned with handle 410 when second rake head 440 is coupled to body 421 through second aperture 424. This may allow use of second rake head 440 to feel more natural to a user. In some embodiments, an angle is formed between first rake head 430 and second rake head 440 based on the internal angles of first aperture 423 and second aperture 424. In the particular implementation shown in FIG. 4B, the angle is approximately equal to 10 degrees.

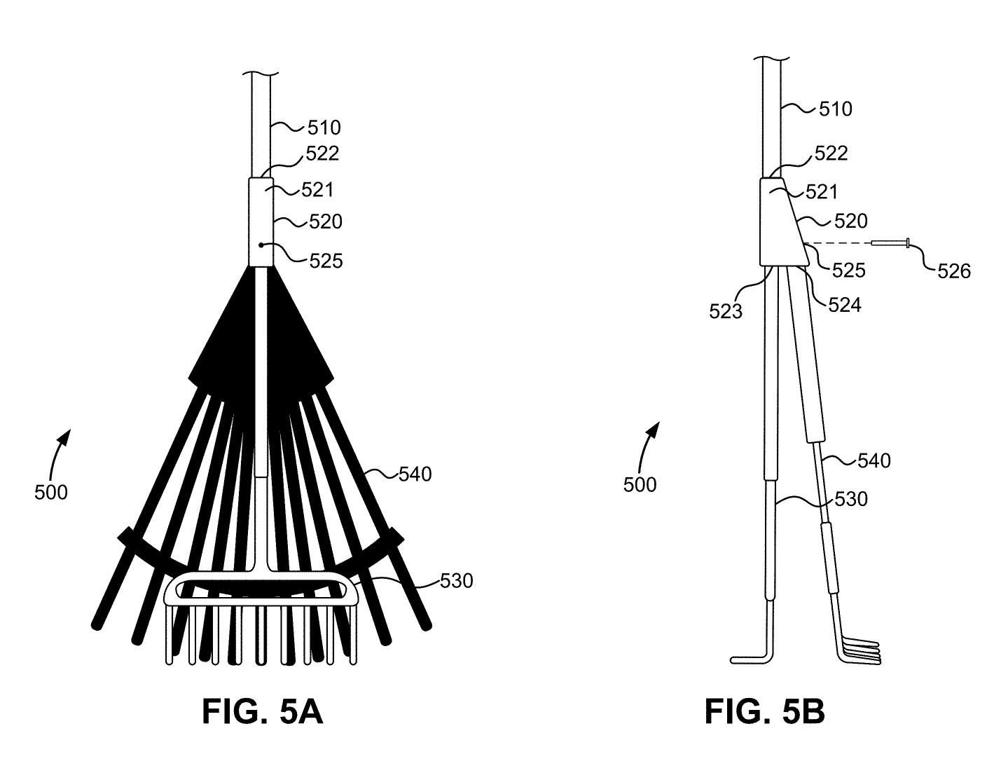

FIG. 5A illustrates a front view of a raking device 500, according to an embodiment of the present disclosure. One or more components of raking device 500 may be similar or different than one or more components of raking devices 100, 200, 300, and 400. In some embodiments, raking device 500 includes a handle 510 coupled to a rake adapter 520 having a body 521 comprising a plurality of apertures, including a first aperture 523 at a bottom end of body 521 configured to receive a first rake head 530, a second aperture 524 at a bottom end of body 521 configured to receive a second rake head 540, a top aperture 522 at a top end of body 521 configured to receive handle 510, and a side aperture 525 at a side of body 521 configured to receive a fastener 526.

Top aperture 522 may include an internally-threaded portion configured to receive an externally-threaded portion of handle 510 such that the externally-threaded portion of handle 510 may be screwed into the internally-threaded portion of top aperture 522. In other embodiments, top aperture 522 may employ alternative coupling means such as a fitted connection, a bolted connection, and the like. Similarly, side aperture 525 may include an internally-threaded portion configured to receive an externally-threaded portion of fastener 526 such that the externally-threaded portion of fastener 526 may be screwed into the internally-threaded portion of side aperture 525. Alternatively, one or both of the stem portions of first rake head 530 and second rake head 540 may include an aperture for receiving fastener 526, and may further include an internally-threaded portion for receiving the externally-threaded portion of fastener 526. In some embodiments, the stem portions of one or both of first rake head 530 and second rake head 540 may extend through first aperture 523 and second aperture 524 (respectively) at a distance sufficient such that fastener 526 may couple to one or both of first rake head 530 and second rake head 540.

First aperture 523 and second aperture 524 may employ one or more of various possible connection types for coupling to first rake head 530 and second rake head 540, respectively, such as a threaded connection, a fitted connection, a bolted connection, and the like. In some embodiments, first rake head 530 may couple to body 521 through first aperture 523 using a threaded connection, and second rake head 540 may couple to body 521 through second aperture 524 using a bolted connection. Such embodiments may be assembled by first inserting and rotating first rake head 530 followed by inserting second rake head 540. In some embodiments, both first rake head 530 and second rake head 540 may couple to body 521 through first aperture 523 and second aperture 524 (respectively) using a bolted connection. Other possibilities are contemplated.

FIG. 5B illustrates a side view of raking device 500, according to an embodiment of the present disclosure. One or more components of raking device 500 shown in FIG. 5B may correspond to one or more components of raking device 500 shown in FIG. 5A. In some embodiments, first aperture 523 may be aligned with handle 410 such that first rake head 530 is aligned with handle 510 when first rake head 530 is coupled to body 521 through first aperture 523. This may allow use of first rake head 530 to feel more natural to a user. In some embodiments, an angle is formed between first rake head 530 and second rake head 540 based on the internal angles of first aperture 523 and second aperture 524. In the particular implementation shown in FIG. 5B, the angle is approximately equal to 10 degrees.

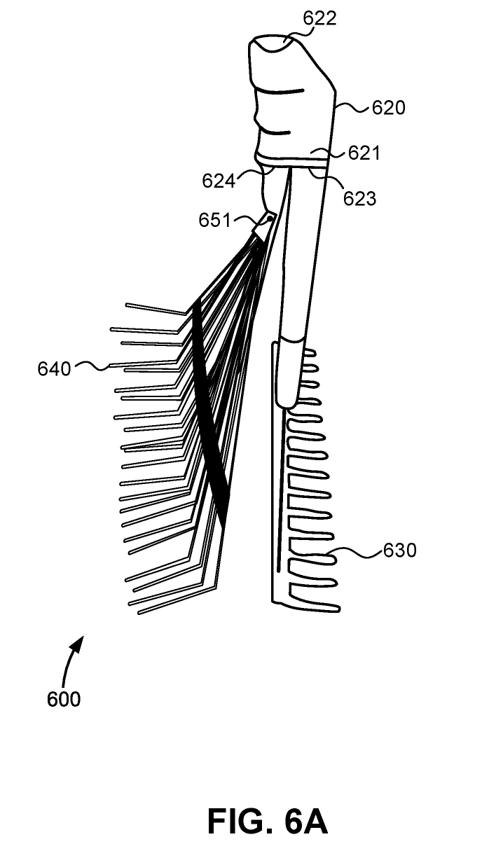

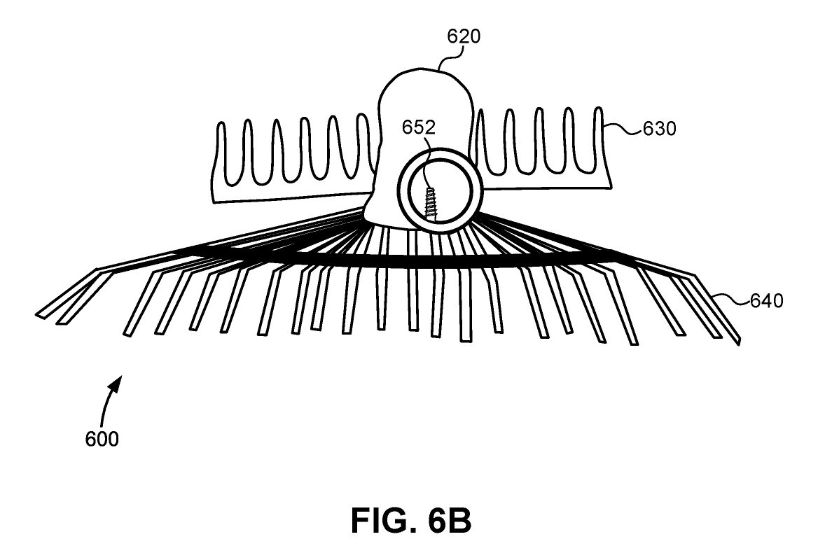

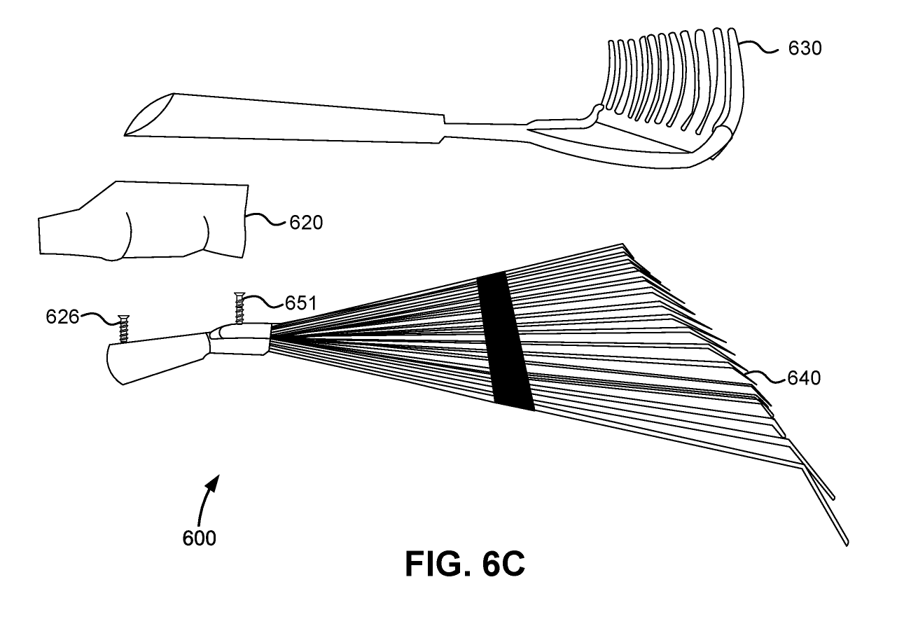

FIG. 6A illustrates a perspective view of a raking device 600, according to an embodiment of the present disclosure. One or more components of raking device 600 may be similar or different than one or more components of raking devices 100, 200, 300, 400, and 500. Raking device 600 may include a handle (not shown) coupled to a rake adapter 620. Rake adapter 620 may also include a body 621 having a first aperture 623 at a bottom end of body 621 configured to receive a first rake head 630, a second aperture 624 at a bottom end of body 621 configured to receive a second rake head 240, and a top aperture 622 at a top end of body 621 configured to receive a handle. In the specific implementation shown in FIG. 6A, second rake head 640 includes a stem fastener 651 for securing a stem portion of second rake head 640 to the rest of second rake head 640. In some embodiments, the stem portion of second rake head 640 may be integrated with rake adapter 620.

FIG. 6B illustrates a perspective view of raking device 600, according to an embodiment of the present disclosure. In some embodiments, raking device 600 may include a top fastener 652 for securing a handle to rake adapter 620.

FIG. 6C illustrates an exploded, perspective view of raking device 600, according to an embodiment of the present disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

### LIST OF TERMS

100—Raking Device
110—Handle
120—Rake Adapter
130—First Rake Head
140—Second Rake Head
200—Raking Device
210—Handle
220—Rake Adapter
221—Body (of Rake Adapter 220)
222—Top Aperture (of Rake Adapter 220)
223—First Aperture (of Rake Adapter 220)
224—Second Aperture (of Rake Adapter 220)
225—Side Aperture (of Rake Adapter 220)
226—Fastener
230—First Rake Head
240—Second Rake Head
300—Raking Device
310—Handle
320—Rake Adapter
321—Body (of Rake Adapter 320)
322—Top Aperture (of Rake Adapter 320)
323—First Aperture (of Rake Adapter 320)
324—Second Aperture (of Rake Adapter 320)
325—Side Aperture (of Rake Adapter 320)
326—Fastener
330—First Rake Head
340—Second Rake Head
400—Raking Device
410—Handle
420—Rake Adapter
421—Body (of Rake Adapter 420)
422—Top Aperture (of Rake Adapter 420)
423—First Aperture (of Rake Adapter 420)
424—Second Aperture (of Rake Adapter 420)
425—Side Aperture (of Rake Adapter 420)
426—Fastener
430—First Rake Head
440—Second Rake Head
500—Raking Device
510—Handle
520—Rake Adapter
521—Body (of Rake Adapter 520)
522—Top Aperture (of Rake Adapter 520)
523—First Aperture (of Rake Adapter 520)
524—Second Aperture (of Rake Adapter 520)
525—Side Aperture (of Rake Adapter 520)
526—Fastener
530—First Rake Head
540—Second Rake Head
600—Raking Device
620—Rake Adapter
621—Body (of Rake Adapter 620)
622—Top Aperture (of Rake Adapter 620)
623—First Aperture (of Rake Adapter 620)
624—Second Aperture (of Rake Adapter 620)
626—Fastener
630—First Rake Head
640—Second Rake Head
651—Stem Fastener
652—Top Fastener

What is claimed is:

1. A raking device comprising:
a handle operable to be held by a user; and
a rake adapter coupled to the handle at a top end of the rake adapter, the rake adapter comprising:
a body comprising a plurality of apertures;
a first aperture at a bottom end of the body configured to receive a first rake head; and
a second aperture at the bottom end of the body configured to receive a second rake head.

2. The raking device of claim 1, further comprising:
the first rake head coupled to the body of the rake adapter through the first aperture; and
the second rake head coupled to the body of the rake adapter through the second aperture.

3. The raking device of claim 2, wherein the first rake head is oriented in a first direction and the second rake head is oriented in a second direction, and wherein the first direction is opposite the second direction.

4. The raking device of claim 2, further comprising:
a fastener coupled to one or both of the first rake head and the second rake head through a side aperture at a side of the body of the rake adapter.

5. The raking device of claim 2, wherein the first rake head and the second rake head form an angle between 5 and 20 degrees.

6. The raking device of claim 1, wherein the rake adapter is integrated with the rake handle.

7. The raking device of claim 1, wherein the rake adapter is configured such that:
the first aperture is aligned with the rake handle such that at least part of the first rake head is aligned with the handle when the first rake head is coupled to the body of the rake adapter through the first aperture; or
the second aperture is aligned with the rake handle such that at least part of the second rake head is aligned with the handle when the second rake head is coupled to the body of the rake adapter through the second aperture.

8. The raking device of claim 1, wherein the rake adapter is stainless steel.

9. The raking device of claim 2, wherein the first rake head is stainless steel.

10. The raking device of claim 2, wherein the second rake head is plastic.

11. A raking device comprising:
a body comprising a plurality of apertures;
a top aperture at a top end of the body configured to receive a handle operable to be held by a user;
a first aperture at a bottom end of the body configured to receive a first rake head; and
a second aperture at the bottom end of the body configured to receive a second rake head.

12. The raking device of claim 11, further comprising:
the handle coupled to the body through the top aperture.

13. The raking device of claim 11, further comprising:
the first rake head coupled to the body through the first aperture; and
the second rake head coupled to the body through the second aperture.

14. The raking device of claim 13, wherein the first rake head is oriented in a first direction and the second rake head is oriented in a second direction, and wherein the first direction is opposite the second direction.

15. The raking device of claim 13, further comprising:
a fastener coupled to one or both of the first rake head and the second rake head through a side aperture at a side of the body.

16. The raking device of claim 13, wherein the first rake head and the second rake head form an angle between 5 and 20 degrees.

17. The raking device of claim 12, wherein the raking device is configured such that:
the first aperture is aligned with the rake handle such that at least part of the first rake head is aligned with the handle when the first rake head is coupled to the body through the first aperture; or
the second aperture is aligned with the rake handle such that at least part of the second rake head is aligned with the handle when the second rake head is coupled to the body through the second aperture.

18. The raking device of claim 11, wherein the body is stainless steel.

19. The raking device of claim 13, wherein the first rake head is stainless steel.

20. The raking device of claim 13, wherein the second rake head is plastic.
